(19) United States
(12) Patent Application Publication
(10) Pub. No.: US 2012/0202525 A1
(43) Pub. Date: Aug. 9, 2012

(54) METHOD AND APPARATUS FOR DISTRIBUTING AND DISPLAYING MAP EVENTS

(75) Inventor: Stefano Pettini, Berlin (DE)

(73) Assignee: Nokia Corporation, Espoo (FI)

(21) Appl. No.: 13/079,187

(22) Filed: Apr. 4, 2011

Related U.S. Application Data
(60) Provisional application No. 61/440,715, filed on Feb. 8, 2011.

(51) Int. Cl. H04W 4/02

(52) U.S. Cl. 455/456.3

(57) ABSTRACT

An approach is provided for distributing and displaying map events. A map event distribution platform processes and/or facilitates a processing of at least one map event specified by a user. The map event distribution platform determine to encode information regarding the at least one map event. The map event distribution platform cause, at least in part, transmission of the encoded information to one or more devices associated with one or more other users. The map event information is processed, at least in part, to be associated with a map application, at least to modify a locally-stored device map, and/or to affect the mapping and navigation behaviors of the map application.

### RELATED APPLICATIONS

This application claims the benefit of the earlier filing date under 35 U.S.C. §119(e) of U.S. Provisional Application Ser. No. 61/440,715 filed Feb. 8, 2011, entitled “Method and Apparatus for Distributing and Displaying Map Events,” the entirety of which is incorporated herein by reference.

### BACKGROUND

Service providers (e.g., wireless and cellular services) and device manufacturers are continually challenged to deliver value and convenience to consumers by, for example, providing compelling network services and advancing the underlying technologies. One area of interest has been the development of location-based services available to, for instance, mobile devices and/or other user devices. Despite the utility of mapping and navigation services, a common problem related to providing such services relates to the availability and/or maintenance of maps that are up to date or current. For example, historically, mapping and navigation applications provide updates as transfers of the entire map data set even when only a small part of the map data set has been updated. Accordingly, service providers and device manufacturers face significant technical challenges to facilitating updates of map data sets and/or related information (e.g., map events such as traffic conditions, temporary obstructions, corrections, etc.) while also minimizing the amount of data that is to be transferred between mapping services and their end users.

### SOME EXAMPLE EMBODIMENTS

Therefore, there is a need for an approach for generating map events, distributing and displaying map events.

According to one embodiment, a method comprises processing and/or facilitating a processing of at least one map event specified by a user. The method also comprises determining to encode information regarding the at least one map event. The method further comprises causing, at least in part, transmission of the encoded information to one or more devices associated with one or more other users. The map event information is processed, at least in part, to be associated with a map application.

According to another embodiment, an apparatus comprises at least one processor, and at least one memory including computer program code, the at least one memory and the computer program code configured to, with the at least one processor, cause, at least in part, the apparatus to process and/or facilitate a processing of at least one map event specified by a user. The apparatus is also caused to determine to encode information regarding the at least one map event. The apparatus is further caused to cause, at least in part, transmission of the encoded information to one or more devices associated with one or more other users. The map event information is processed, at least in part, to be associated with a map application.

According to another embodiment, a computer-readable storage medium carries one or more sequences of one or more instructions which, when executed by one or more processors, cause, at least in part, an apparatus to process and/or facilitate a processing of at least one map event specified by a user. The apparatus is also caused to determine to encode information regarding the at least one map event. The apparatus is further caused to cause, at least in part, transmission of the encoded information to one or more devices associated with one or more other users. The map event information is processed, at least in part, to be associated with a map application.

According to another embodiment, an apparatus comprises means for processing and/or facilitating a processing of at least one map event specified by a user. The apparatus also comprises means for determining to encode information regarding the at least one map event. The apparatus further comprises means for causing, at least in part, transmission of the encoded information to one or more devices associated with one or more other users. The map event information is processed, at least in part, to be associated with a map application.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of distributing and displaying map events, according to one embodiment;

FIG. 2 is a diagram of the components of a map event distribution platform, according to one embodiment;

FIG. 3 is a diagram of the components of user equipment, according to one embodiment;

FIG. 4 is a flowchart of a process for encoding and displaying map events, according to one embodiment;

FIG. 5 is a flowchart of a process for decoding and displaying map events, according to one embodiment.

FIGS. 6-8 are diagrams of user interfaces utilized in the processes of FIGS. 4-5, according to various embodiments.

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for distributing and displaying map events are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term “social graph” refers to a data structure or a group of data structures (e.g., list, table, etc.) that store connection and relationship information between users (e.g., connections via accounts of users). The graph is created on a user-by-user basis to represent links created by a particular user over one or more social networking services. The totality of these social connections and relationships among users are commonly known as social graphs. Social networking services often make it easy for a user to create such connections.

Although various embodiments are described with respect to microblogging (e.g., tweeting via the Twitter® microblogging service) map changes and events, it is contemplated that the approach described herein may be used with other messaging mechanisms, such as text messaging, instant messaging, short messaging, email, web feeds, or a combination thereof.

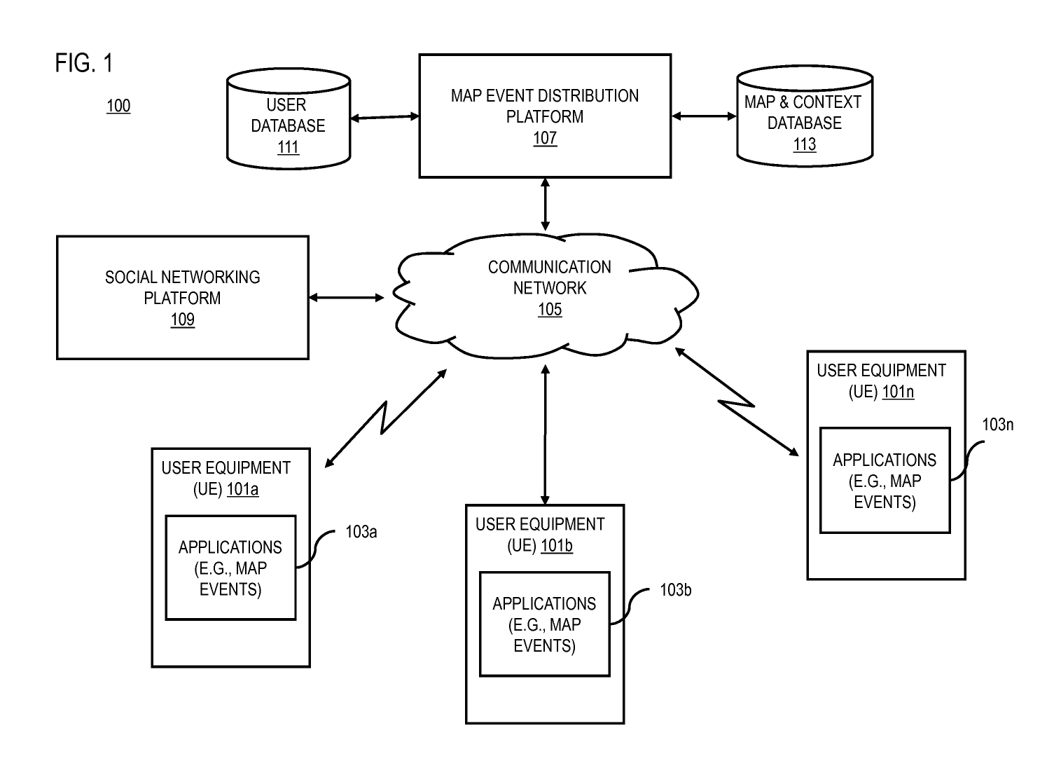

One area of interest has been the development of mapping and navigation services and other services for sharing map events among users. FIG. 1 is a diagram of a system capable of distributing map events to users, according to one embodiment. In certain embodiments, the term map event refers to occurring map events such as traffic jams, speed cameras, etc. as well as scheduled map events and/or relevant content such as time periods (e.g., road work, utilities installation, etc.). The content may be in different media types, e.g., icons, pop-ups, pictures, video, audio, wallpapers, themes, games, etc., to be executed or presented on user equipment (e.g., a mobile device). An occurring event can be a transient event, like a traffic jam, an emergency or temporary closure of a road, or a more stable map change, such as existing pedestrian shortcuts, fixed speed cameras, road attributes permanent changes (e.g., the one-way or pedestrian-only attributes), suitability of a road for pedestrian routing (e.g., street cleaning, etc.), and so on.

Although various embodiments are described with respect to a map event distribution platform and user equipment, it is contemplated that the approach described herein may be used with other platforms and computing devices. Map event distribution platforms such as mapping and/or navigation systems are utilized to provide content map events to users of the platforms. As the content available on the platforms become greater, it becomes more difficult for a user to navigate and it also becomes more difficult for the platforms to determine what content is relevant to the user.

As mentioned, existing map event reporting methods can be cumbersome and time consuming, and require special map event sharing software to upload map events online. By way of example, when a user desires to change the user's own map supported by a mapping and/or navigation system, the user may have to start map event reporting software on a stand-alone GPS device in order to enter the map events. When the user gets home or office, the user then connects the GPS device to a computing device (e.g., a PC, etc.) to upload the map events and notify the system the changes. Thereafter, the changes (e.g., street name edits, driving directions modifications, blocking and unblocking streets, etc.) can be made into the local map in the GPS device, or to share via the system with other users.

In addition, traditional map event reporting methods generally support only fixed types of map events to be reported via fixed choices. By way of example, traditional map event reporting software may present pre-determined screen shots for the user to enter six different types of changes to the local map: (un)block a street in one or both directions, reverse direction, name or rename a street, add a point of interest (POI), remove or rename a POI, add or change a POI phone number. The map event sharing software may only support uploading fixed types of map errors to the system, such as new/missing roads, exits, rotaries, etc. Map event sharing is done depending upon the sharing channels, such as emails, SMS, web feeds, etc., predetermined by the map and navigation service providers.

To address these problems, a system 100 of FIG. 1 introduces the capability to distribute map events to users independently of sharing channels predetermined by different communication service providers, mapping and navigation systems, etc. The system 100 allows users to efficiently modify their own map events, share these events with others, and receive and integrate map events from others back on their maps, regardless sharing channels, communication service providers, mapping and navigation systems, etc. In one embodiment, the system 100 receives user inputs of map changes and events on their own devices, stores the changes and events a on the device, and then affects local routing, map display and navigation accordingly. Users may preview map changes and events on the device prior to accepting the changes and events on the device. In another embodiment, the system 100 encodes the changes and events into messages that are transmitted to other user devices and/or a mapping service platform to share with other users. In one embodiment, a change/event is encoded into a short microblogging (e.g., Twitter®) message. By way of example, microblogging messages may have a maximum length (e.g., 140 characters). Accordingly, the system 100 generates the encoded change/event information to fit within the maximum length. The encoded change/event information may include an event types (traffic jams, etc.), a road ID, coordinates of the event, attributes of the event (timestamps, reporting users, etc.), etc. A typical encoded message may appear like: “*AQC6r+NMAQNEVAQ7YaJVFg/SYOQ=#”. This encoded message is then transmitted to followers via the microblogging service.

In another embodiment, the system 100 allows the user device to automatically or manually receive incoming messages of map changes and events via syndication feeds (e.g., Really Simple Syndication (RSS) feeds from partners, third parties, communities on the web, etc.). The system 100 then decodes map changes and events from received messages and applies them locally to the map at the user device. After viewing the changes and events, the user may retransmit (e.g., retweet via Twitter®) some or all of the changes and events to the user's followers, social networks, or other members of the user's social graph.

As shown, user equipment (UEs) 101a-101n can execute applications 103a-103n (e.g., map event applications, social networking applications, contacts applications, games, utilities, media players, market application, etc.) and manipulate digital content (e.g., programs, media, etc.). A user may invoke applications 103 to communicate via a communication network 105 with platforms such as a map event distribution platform 107 and/or a social networking platform 109. The UE (e.g., UE 101a or UE 101b) may be connected to the communication network 105 wirelessly or through a wired connection. The map event distribution platform 107 receives user inputs indicating map changes and events and displays them at the UE 101. Further, the map event distribution platform 107 may be utilized to encode and distribute map changes and events for the user.

In addition to map changes and events, the map event distribution platform 107 (e.g., a mapping and/or navigation system) can be utilized to distribute other digital content to the user's UE 101 or other UEs. The map event distribution platform 107 may collect data about the user as well as other users and store the data in a user database 111. This user data may include information about the user (e.g., user profile information such as a user identifier, name, contact information such as an e-mail address or phone number, description of the user, etc., navigation routes, points of interest, information about connections to the user (e.g., friends, family, colleagues, contacts, etc.), information about map events the user has acquired and/or utilized, or the like), etc. Further, the map event distribution platform 107 may include a map and context database 113 that includes map and context data that may be displayed locally and/or distributed externally (e.g., map events and context such as time, attributes, etc.). Users may utilize an application 103, such as a map event application on the user's UEs 101a-101n to access the map event distribution platform 107.

To determine distributions of map changes and events for the user, the map event distribution platform 107 can receive and monitor map and context information associated with social connections or relationships to the user. These social connections may be provided via contact information associated with the user and/or UE 101 as well as via one or more social networking services.

Social networking services may be provided by the social networking platform(s) 109. In certain embodiments, a social networking platform 109 is a platform, such as a computing device, that may be utilized to coordinate and facilitate communications between UEs 101. Examples of social networking platforms 109 include social networking websites and services (e.g., Facebook™, Twitter™, MySpace™ etc.), as well as other computing devices (e.g., a server to coordinate communications between UEs 101). Users may utilize an application 103, such as a social networking application on the user's UEs 101a-101n to access the social networking platform 109. Further, the map event distribution platform 107 and the social network platform 109 may include application programming interfaces (APIs) to communicate with each other. As such, user connection information from the social networking platform 109 may be provided to the map event distribution platform 107.

Additionally or alternatively, the map event distribution platform 107 can retrieve social connection information from one or more UEs 101 of the user. Thus, the map event distribution platform 107 can provide social connection information that may include the relationship status between the user and other users (e.g., via user accounts utilized on one or more social networking platforms 109 and/or contact services). Each of the users may be associated with user identifiers and/or accounts in the user database 111. In certain embodiments, user accounts may be associated with a user identifier, connections to other users (e.g., via contact information), and map events that were either acquired by the user via the account or otherwise present on a UE 101 of the user associated with the account. Moreover, a social graph can be generated and stored in the user database 111 to associate the account of one user to the accounts of other users. Further, the social connections in the social graph can be based on contact information associated with one or more accounts (e.g., an e-mail account, a messaging account, etc.) associated with the user. The map event distribution platform 107 may have access to these accounts and contact information via an API. In certain embodiments, groups (e.g., family, friends, colleagues, co-workers, acquaintances, etc.) may be depicted or described as social graphs within the user accounts. Further, groups associated with a social graph can be automatically organized based on how the user is connected with other users. The connections may additionally be provided values of how reliable, trustworthy, or alike the user is to the other users. For example, the trustworthiness of a user who is a friend on a social networking service may be more trustworthy than a user who is merely a contact (e.g., via an e-mail account). Moreover, privacy rules (e.g., rules for allowing access for certain people to view the user's map events) may be implemented based on these relationships.

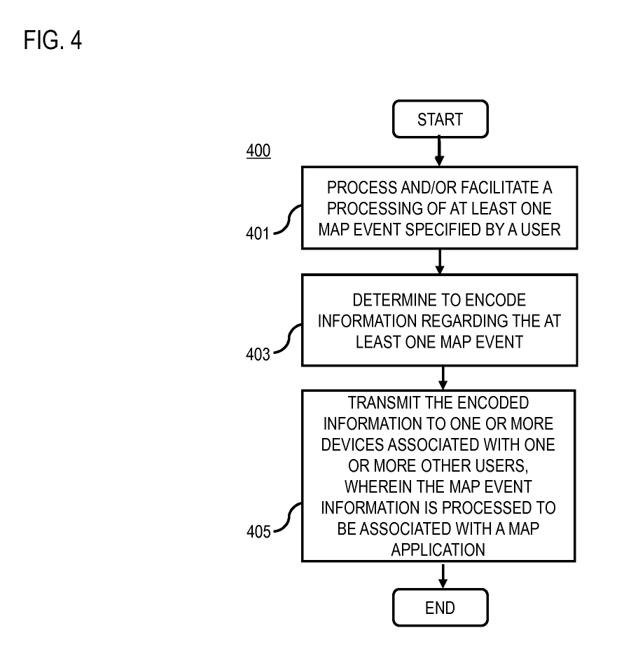

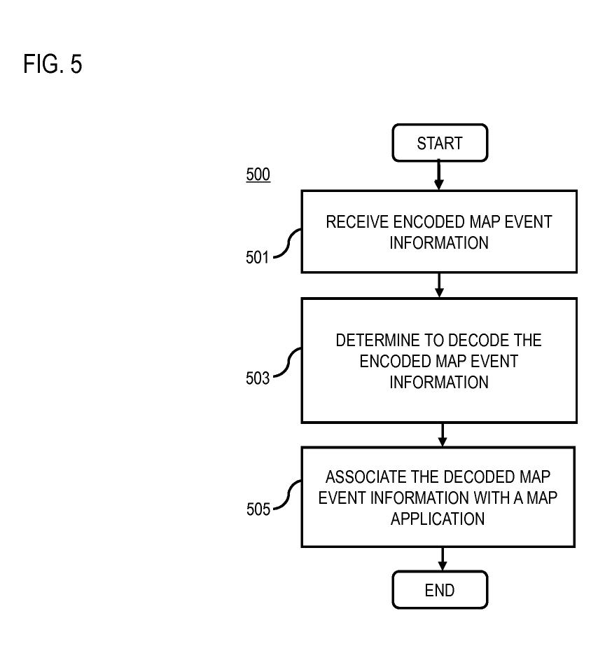

In some embodiments, the user can utilize an application 103 to access the map event distribution platform 107 to acquire and/or subscribe to map events from the platform 107 and/or other users. During the process, the UE 101 can present the user with map events associated with user accounts connected to the user in a social graph of the user. The map event distribution platform 107 or an application 103 on the UE 101 can determine which users to present via processes further detailed in FIGS. 4-5. These other users may be selected by stratifying the other user accounts based on the frequency of communication between the user and the other users, social network distance (e.g., how far away is the connection like is the other person a friend, a friend of a friend, colleague, etc.), context matching or interest profile matching (e.g., via a similarity ranking algorithm), user specification (e.g., via user specified criteria or input selection), or a combination thereof. User accounts more closely related to the user may be selected. As such, one or more of the user accounts may be presented to the user. The user may then select one or more of the user accounts to view a presentation of map events associated with the other user accounts.

Further, in certain embodiments, a user can be encouraged to contribute map event information to the map event distribution platform 107 by providing rewards to users partaking in the service. As such, the user can receive reward points (e.g., electronic funds, a credit, etc.) for contributing reliable map event information. In certain scenarios, the rewards points can be utilized to increase the creditability of a user by the map event distribution platform 107.

As shown in FIG. 1, the system 100 comprises a user equipment (UE) 101 having connectivity to the map event distribution platform 107 and the social networking platform 109 via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), or any combination thereof. It is also contemplated that the UE 101 can support any type of interface to the user (such as “wearable” circuitry, etc.).

By way of example, the UE 101, social networking platform 109, and map event distribution platform 107 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

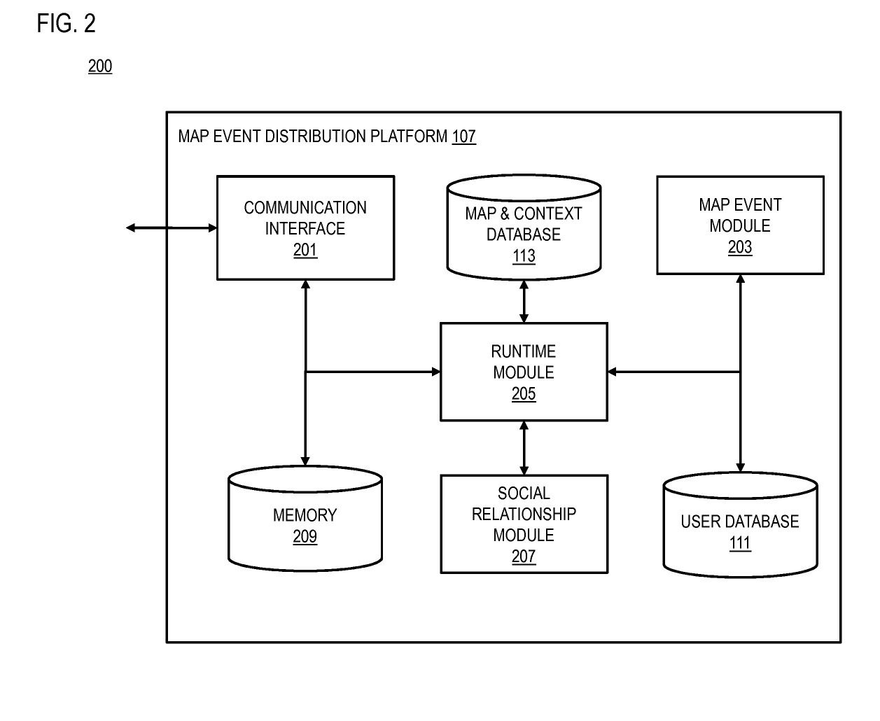

FIG. 2 is a diagram 200 of the components of a map event distribution platform, according to one embodiment. By way of example, the map event distribution platform 107 includes one or more components for determining and generating a presentation of map events to a user of a UE 101. It is contemplated that the functions of these components may be combined in one or more components or performed by other components of equivalent functionality. In this embodiment, the map event distribution platform 107 includes a communication interface 201, a map event module 203 that can be used to verify reported map events and update users with verified map events (e.g., by common elements of the same event, information about the creditability of a reporting user, etc.), a runtime module 205 that can execute processes, a social relationship module 207 that can determine relationships between user accounts, a user database 111, a map and context database 113 associated with map events, and a memory 209.

In one embodiment, the map event distribution platform 107 includes the communication interface 201. The communication interface 201 can be used to communicate with a UE 101 and social networking platform 109. The map event distribution platform 107 can receive information (e.g., map events) from the UE 101 and information (e.g., social graphs) from the social networking platform 109 via the communication interface 201 via methods such as internet protocol, Multimedia Messaging Service (MMS), Short Message Service (SMS), GPRS, or any other available communication method. The UE 101 can send information to the map event distribution platform 107 for many reasons, such as to update the map event distribution platform 107 as to a map event has been reported by the UE 101.

The map event module 203 may receive map events from UEs 101 associated with users to update map information associated with the user and/or other users who are designated to share the map event with the user. Beside the map event data, the message may include a sender ID (e.g., the originating user of the map event), one or more receiver IDs (e.g., users designated to share the map event, the map event distribution platform 107, or a combination thereof.

In one embodiment, the map event module 203 may decode one or more received map event messages from UEs 101 and generates a mapping display accordingly. The mapping display can be shared by the users who are designated by the user and/or whoever subscribes to the mapping service of the map event distribution platform 107. In another embodiment, the map event module 203 decodes one or more received map event messages to extract the user's information and the map event data, and then transmits the received map events directly (without displaying) to the users who are designated by the user and/or whoever subscribe to the mapping service of the map event distribution platform 107.

In one embodiment, the map event messages were encoded according to a standard format, in order to be transmitted and processed efficiently. By way of example, a map event was encoded into a message of a fixed or variable length such as Twitter® messages (e.g., limited to messages with a maximum of 140 characters to be transmitted to followers). A maximum character limit (e.g., 30 characters) other than the maximum message length (e.g., 140 characters) may be implemented by the map event module 203 or existing URL shortening services such as bit.ly, goo.gl, tr.im, etc. The character limit can result in improved power consumption efficiency, thus extending operation time and the battery life of the UE 101.

In one embodiment, the map event messages also include shorthand notations to encode the content to further reduce message sizes. The map event module 203 decodes the received messages based upon the encoding or shorthand format. Information to identify the encoding format may be included in the messages or transmitted separately.

In another embodiment, the communication interface 201 allows the map event distribution platform 107 to receive incoming data of map changes and events via web feeds (e.g., Really Simple Syndication (RSS) feeds, Atom, etc.). The map event module 203 may subscribe to entities, such as partners (e.g., traffic news content providers, etc.), 3rd parties (e.g., weather content providers, etc.), communities on the web (e.g., marathon organizers, etc.), users, etc. For map event data, and then aggregates map changes and events from received web feeds. The map event module 203 can then apply the map events to the map for the users to browse online, or encode the data into map event messages as discussed above, or publish the aggregated data via web feeds to other entities. Feed readers may be online (like a web-mail account) or offline. An offline web feed is downloaded to the map event distribution platform 107. The web feeds are typically in HTML (webpage content) or links to web pages and other kinds of digital media, and the web feeds can be integrated into a browser. When websites provide web feeds to notify users of content updates, the notification may include summaries in the web feed or the full content itself.

In one embodiment, the map event module 203 verifies the truthfulness of user-reported map events. The verification can be processed automatically by machine-based algorithms, or semi-automatically, or manually by map content administrators. The administrators or the map event module 203 uses a process or algorithm of verification to determine the precise location of a map event and validity of the map event. When a map event is verified, it is reflected in the system map or encoded into a message to be transmitted to the users. After verifying the changes and events, the map event module 203 may transmit some or all of the changes and events to subscribers and/or followers. If the map event cannot be verified, it is maintained in the map and context database 113 for potential further review.

To send a decode message to other users, the map event module 203 re-encodes the decoded messages based upon the same encoding format or a different encoding format. The re-encoded message may include an ID of the originating user of the map event, an ID of the map event distribution platform 107, one or more IDs of other users, or a combination thereof.

In one embodiment, the encoded map event messages are transmitted to the users who are designated by the user and/or whoever subscribes to the mapping service of the map event distribution platform 107. In another embodiment, notification of the map events is transmitted to the users who are designated by the user and/or whoever subscribes to the mapping service of the map event distribution platform 107, and then the users can browse a mapping display via the web that contain the map events.

The map event information can include map events that the user has subscribed from the map event distribution platform 107, other map event platforms or mapping and/or navigation systems, etc. In certain embodiments, the map events are digital content such as traffic jams, etc. The map event information may additionally include information on the credibility of the user that reports the map event. In some embodiments, the map events are social events (e.g., concerts, gatherings, etc.) for the UE 101. In these embodiments, the map event information may include event completion information (e.g., a percentage of the event complete, etc.). The map event information may include a measure of how accurate the user reports and/or evaluates the map event that is based upon the truthfulness of user-reported map events. This information may be utilized by the map event module 203 to determine whether to present the map event to other users. The map event information may be associated with the user account in the user database 111. Further, any user information included in a map event message or web feed may be filtered based on privacy features set by the user.

In certain embodiments, the map event module 203 retrieves locally a social graph associated with the user. In other embodiments, the map event module 203 can receive social graphs and social connection information (e.g., receive contact information and/or a contact history (e.g., call history) from a UE 101 and/or the social networking platform 109. With the social connection information, the map event module 203 may determine which users associated with the user in the user database 111 to transmit information of map events.

In certain embodiments, the social relationship module 207 connects to the social networking platform 109 via an API to retrieve a social graph associated with the user. In other embodiments, the social relationship module 207 can receive social graphs and social connection information from a UE 101 (e.g., receive contact information and/or a contact history (e.g., call history)). With the social connection information, the social relationship module 207 may update local social graphs associated with the user in the user database 111.

In one embodiment, the social relationship module 207 can receive username and password, or other authentication information, from the user and use the authentication information to access the user's social network. The social relationship module 207 can then access the social graph to determine relationships between the user and other users. Users may be identified using common identifiers (e.g., a user name, e-mail, a phone number, address, etc.). In this manner, user accounts associated with other users can be matched to user information in the received social graphs from the social networking platform 109. Additionally or alternatively, the user may provide friend contact information, and the social relationship module 207 can determine the social graph.

The communication interface 201 may additionally be utilized to add content to the map and context database 113. The map and context database 113 may be populated by the runtime module 205 to include map events such as digital content (e.g., applications 103, media, etc.). Further, the map and context database 113 may include icons, description information, and other information associated with map events. This information may be presented to a user when the user is searching for map events.

When the user searches for map events from the map event distribution platform 107, the user can request other user information via the communication interface 201. The runtime module 205 receives the request and associates the user with an account in the user database 111. The runtime module 205 then retrieves a social graph from the user database 111 and determines and recommends other users from the social graph to present to the user. The other users may be determined based on various predetermined criteria, such as college classmates, computer company co-workers, friends living within a 5 mile radius of a POI, etc. Information associated with the other users may be transmitted and presented to the user on the user's UE 101. The user may then select visual representations of the other users presented via the UE 101. The runtime module 205 receives the selection of other users and determines map events associated with the selected other users. In another embodiment, the runtime module 205 receives map events from the user, determines other users associated with the map event for the user to select, and then transmit the map events to the selected users. The runtime module 205 causes the presentation by initiating transmission of map event information over the communication interface 201. The map events are then presented to the other users.

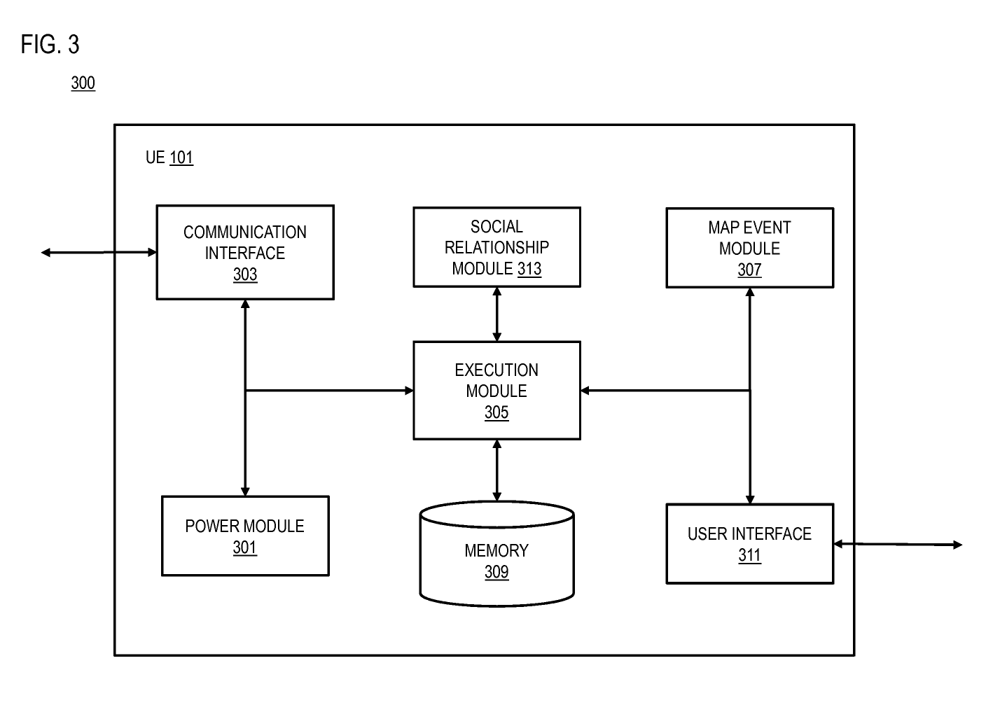

FIG. 3 is a diagram 300 of the components of user equipment, according to one embodiment. It is contemplated that the functions of these components may be combined in one or more components or performed by other components of equivalent functionality. In this embodiment, the UE 101 includes a power module 301 to provide power and power controls to the UE 101, a communication interface 303 to communicate over a network, an execution module 305 to control the runtime of applications executing on the UE 101, a map event module 307 for determining use information of map events, a memory 309, a user interface 311 to output and receive input at the UE 101, and a social relationship module 313 to update social connection information in the memory.

As shown, the UE 101 includes a power module 301. The power module 301 provides power to the UE 101. The power module 301 can include any type of power source (e.g., battery, plug-in, etc.). Additionally, the power module 301 can provide power to the components of the UE 101 including processors, a memory 309, and transmitters.

The communication interface 303 may include multiple means of communication. For example, the communication interface 303 may be able to communicate over SMS, internet protocol, instant messaging, voice sessions (e.g., via a phone network), or other types of communication. The communication interface 303 can be used by the execution module 305 to communicate with other UEs 101, the map event distribution platform 107, the social networking platform 109, and other devices. In some examples, the communication interface 303 is used to transmit and receive web feeds associated with map events and information associated with other users that may be socially connected with the user.

In one embodiment, a UE 101 includes a user interface 311. The user interface 311 can include various methods of communication. For example, the user interface 311 can have outputs including a visual component (e.g., a screen), an audio component, a physical component (e.g., vibrations), and other methods of communication. User inputs can include a touch-screen interface, a scroll-and-click interface, a button interface, etc. In certain embodiments, the user interface 311 may additionally have a vocal user interface component. As such, a text-to-speech mechanism may be utilized to provide textual information to the user. Further, a speech-to-text mechanism may be utilized to receive vocal input and convert the vocal input into textual input. Moreover, the user interface 311 may be utilized to present information associated with other uses and map events associated with other users.

In certain embodiments, a mapping and/or navigation application or a map event acquisition application may execute on the execution module 305. Thus, the user may utilize the execution module 305 to connect to a map event distribution platform 107 to send map events reported by the user and/or to receive map events reported by other users. As such, this map event information may be presented to the user via the user interface 311. Further, the user may interact with the map event distribution platform 107 via the user interface 311. In certain instances, the map event includes digital content (e.g., applications, icons, etc.) that can be executed on the execution module 305 and/or presented via the user interface.

Map event use may be tracked via a map event module 307 that can determine the frequency of use, the number of times used, the completion status of use of an application or game, a combination thereof, or the like. The map event use information may be stored in the memory 309. The execution module 305 can be utilized to provide the map event use information to the map event distribution platform 107 to allow for the user's map event information to be accessed in determining map events to present to a user.

A social relationship module 313 encodes, decodes, verifies, distributed map events in manners similar to the map event module 203 as discussed above. The social relationship module 313 is also utilized to acquire social graphs and/or other social relationship information. Once social graphs and/or social relationship information are acquired, the user may use them to determine which other users to distribute map event information. The social relationship module 313 can be utilized to determine contacts that the user has. The social relationship module 313 may additionally determine communications between the users' UE 101 and the contacts. This information may be stored in memory 309. The social relationship module 313 can be utilized to synchronize contact information with other platforms (e.g., the social networking platform 109, the map event distribution platform 107, etc.) as well as update information of communications (e.g., phone calls, text messages, instant messages, etc.) between the user and contacts (e.g., the frequency of communications, the recentness of communications, or the like). This information may additionally be utilized by the map event module 307 and/or the map event distribution platform 107 to determine relationships between the user and contacts (e.g., which contacts are closer in relationship to the user), in order to recommend to the user of the UE 101 which other users to receive map event information.

The map event module 307 can be utilized to determine how well the user reports a particular map event and/or how well the user likes a particular map event that is reported by another user. This information may be useful for the map event distribution platform 107 for determining whether to present and/or a priority order of map events to present to the user the received map events, or to other users viewing the user reported map events, or to all users subscribe to the map event distribution platform 107.

Additionally or alternatively, the map event distribution platform 107 utilizes social connection information from the social relationship module 313. As such, privacy settings may be utilized by the UE 101 and/or map event distribution platform 107 as to what user information can be used by the map event distribution platform 107. In this manner, the user is able to select the information gathered by the social relationship module 313, map event module 307, and other user information that the user wishes to provide to the map event distribution platform 107 for distributing map events to other users. Thus, the user may utilize privacy features to limit access to other users to view the user's map events or use of map events to users that are in a certain group (e.g., friends, colleagues, friends of friends, etc.) or to users that are not part of the group. By way of example, the user can limit access of co-workers to view the user's map events during office hours. As another example, the user can specify map events associated with the user after office hours can only be presented to friends of the user. As such, colleagues and friends of friends may be denied access to view map events reported by the user after office hours.

Further, the user may select an option to allow colleagues or co-workers access to only the user reported map events associated with work and/or business. Thus, the user's personal life can be separated from the user's work life. In certain scenarios, the user can set privacy rules so that the allowance of entire map event categories (e.g., recreation, exercises, office, education, etc.) can be mapped to users or groups of users. The privacy rules and features set by the user can then be provided to the map event distribution platform 107 via the communication interface 303. Further, in certain embodiments, the privacy rules may be set so that the map event distribution platform 107 is not provided certain information the user does not wish shared.

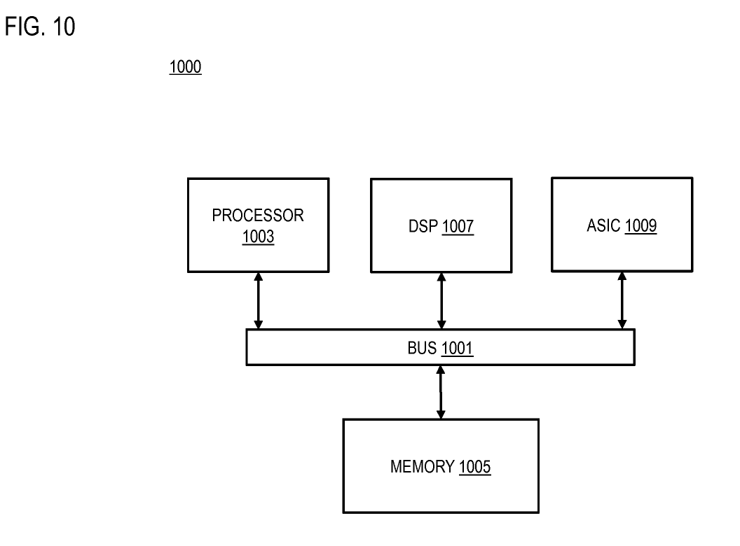

FIG. 4 is a flowchart of a process for encoding and displaying map events, according to one embodiment. In one embodiment, the map event distribution platform performs the process 400 and is implemented in, for instance, a chip set including a processor and a memory as shown in FIG. 10. In step 401, the map event distribution platform 107 (or the map event module 307 of the UE 101, hereinafter) processes and/or facilitates a processing of at least one map event specified by a user. One or more user inputs can be received from the UE 101 on the user interface via typing, touching, clicking, or a combination thereof.

The map event may be a user calendar event, social network event, traffic event, speed camera, road condition, event route, traffic sign, etc. By way of example, the user can report speed cameras and/or traffic jams on a road, road closures, changes of one-way attributes for vehicles and/or pedestrians on a road, etc. As another example, the destination of the user when known by the navigation system, can be shared as a map event with the user's social network, e.g., “where I am,” “where I am going,” etc. As other examples, the reported map events are concerts, shopping mall/restaurant grand openings, etc. associated with existing or new points of interest (POIs). The information of POIs may be retrieved from internal or external location-based databases, such as a place registry, travel website, etc.

The map event distribution platform 107 determines to encode information regarding the at least one map event in a message (Step 403). In one embodiment, the map event distribution platform 107 determines context information associated with the map event information, and determines to include the context information (e.g., time stamps, temperatures, air quality, etc.) in the map event message. The at least one map event may be a transient event report (e.g., traffic jams), an at least substantially persistent event report (e.g., road work), a transient map update (e.g., a trail closure for bear activities), an at least substantially persistent map update (e.g., summer closure of a ski resort), or a combination thereof.

The map event distribution platform 107 uses a communication channel to transmit the message encoded into a compact string of a fix or variable length (e.g., 30 characters). By way of example, the channel can be SMS, email, Twitter®, Facebook®, etc. A compact string can result in improved power consumption efficiency, thus extending operation time and the battery life of the UE 101. In another embodiment, map events are encoded into two-dimensional or three-dimensional barcodes, RFID (NFC (=near field communication)) tags etc. In yet another embodiment, map events are written by hand on a post-it note, optically scanned (e.g., optical character recognition) or intelligently word recognized into digital text, and then encoded as discussed. In yet another embodiment, map events are written by hand on touch-screens or other devices and then encoded accordingly.

In another embodiment, the map event distribution platform 107 processes and/or facilitates a processing of at least one other map event (e.g., a road closure and an alternate route as results of a reported concert) to encode other information (e.g., an operating time frame of the alternate route) regarding the at least one other map event in the message.

The map event distribution platform 107 causes, at least in part, transmission of the message to one or more devices associated with one or more other users (Step 405). In one embodiment, the map event distribution platform 107 determines the one or more devices to receive the map event message based, at least in part, on at least one social network (e.g., LinkedIn®), at least one social graph, or a combination thereof associated with the user. By way of example, the map event distribution platform 107 receives a subscription request for the at least one map event from at least one other user of the at least one social network.

Optionally, prior to the transmission of the message, the map event distribution platform 107 receives from the UE 101a user input for approving the transmission of the message. The map event information may be transmitted via text messaging, instant messaging, short messaging, email, micro-blogging, web feed, or a combination thereof.

The map event information is processed, at least in part, to be associated with a map application. In one embodiment, the map event information is integrated into the map application. Mapping display is then generated by the map application, at least in part, based on the map event information. Optionally, prior to rendering the map display, the map event distribution platform 107 receives from the UE 101a user input for approving the updating of the map. The reported map events are stored on the database of the platform 107 and/or the UE 101. Beside map display, the reported map events can affect routing and navigation. By way of example, when a road block event is reported by the user, a routing engine of the mapping and navigation system can avoid using that road. In another embodiment, the map event distribution platform 107 integrates the reported map events into a website, and allows the user to share the map events via one or more channels with other users without leaving the website.

FIG. 5 is a flowchart of a process for decoding and displaying map events, according to one embodiment. In one embodiment, the map event distribution platform performs the process 500 and is implemented in, for instance, a chip set including a processor and a memory as shown in FIG. 10. In step 501, the map event distribution platform 107 (or the map event module 307 of the UE 101, hereinafter) receives encoded map event information. In another embodiment, the map event distribution platform 107 also authenticates the received map messages using, for example, the user's credentials.

The map event distribution platform 107 determines to decode the encoded map event information (Step 503). The map event may be a generic traffic event on a road, a road not suitable for pedestrians, a pedestrian shortcut, pedestrian attributes (stairs on a jogging path) of a route, a closure of a public transport stop, a closure of a public transport line, etc.

In another embodiment, map event distribution platform 107 determines that the map event information relates to other map event information (e.g., a car crash in conjunction with a reported traffic jam) reported in at least one other map event message, and determines context information (e.g., the degree of congestion of the traffic jam, human injury, vehicle damages, etc.) associated with the map event information, the other map event information, or a combination thereof. The map event distribution platform 107 can present the map event information, the other map event information, or a combination thereof based, at least in part, on the context information.

In yet another embodiment, the map event distribution platform 107 determines validity information, accuracy information, or a combination thereof associated with the map event information, the other map event information, or a combination thereof.

The validity and accurate of the reported map event may be determined based upon reported map events form a plurality of user devices associated with the same map event, based at least in part on the same location, content, contact, current location, message format, or a combination thereof. In another embodiment, the validity and accuracy of a map event is determined based on third party information sources (e.g., live reports by a TV station, announcements by public authorities, etc.), site investigation by the staff of a service provider, etc.

By way of example, the map event information was encoded as a compact string representation made by printable characters. The map event distribution platform 107 can detect the compact string representation of a map event inside a longer text message that may contain extra characters before and after the string. The map event distribution platform 107 can check the integrity of a given string to detect malformed map events. The map event distribution platform 107 can analyze one or more incoming map event messages at the same time to check if they are not malformed, not expired, not already stored locally, as a valid event. If the map event distribution platform 107 determines that it does not already have a newer map event of the same type, the map event information is stored.

The map event distribution platform 107 causes, at least in part, association of the decoded map event information with a map application (Step 505), for example to modify a locally-stored device map, and/or to affect the mapping and navigation behaviors of the map application. The presentation of the map event information, the other map event information, or a combination thereof is based, at least in part, on the validity information, the accuracy information, or a combination thereof. By way of example, when a map event is determined as questionable, the platform 107 may discard it, display it as “cannot be verified,” etc.

By way of example, the map event distribution platform 107 updates a world map provided by a mapping service (e.g., Navteq®) and/or stored locally at the UE 101 with the event information. In one embodiment, the mapping service provides the complete world map data as needed or as subscribed, e.g., monthly, quarterly, annually, etc. On the other hand, map events can be provided any time for updating the world map, and the process only modifies a limited number of map objects that are within the world map and/or compatible with a world map update or version. These event updates are done incrementally and/or in real time, and they can be used for generating additional notes or the like in the local map stored in the UE 101. These additions are small in size and can be efficiently distributed to other user devices as directed by the user or according the subscription by the other users to receive the map events of the user.

The map event distribution platform 107 has an interface to a map application (e.g., for the world map). In one embodiment, the map event distribution platform 107 adds/integrates the map event information into a new world map version when new world map version is installed in the UE 101, when the map event information is already added/integrated into the earlier map application/version and the map events persist. In one embodiment, the map event distribution platform 107 skips/deletes some map event information without adding into a new world map version when new world map version is installed in the UE 101, since the relevant map events (e.g., road construction completed) do not exist anymore.

Decoded map events are stored on the database of the platform 107 and/or the UE 101. Modification to the map events will affect routing, navigation and map display. If a road block event is received, then a routing engine of the mapping and navigation system will avoid using that road. This is also applicable to traffic jam reports, etc. The navigation system may trigger a reroute due to traffic conditions.

In another embodiment, the map event distribution platform 107 determines to re-encode the map event information in at least one other map event message, and causes, at least in part, transmission of the at least one other map event message one or more other users. The one or more other users may be explicitly designated by the reporting user in the received map event message, determined by the platform 107 based on one or more criteria specified by the reporting user in the message, determined by the platform 107 based on one or more criteria specified by the reporting user as default, determined by the platform 107 based on one or more default criteria, etc. The map event distribution platform 107 may use the same or a different format to re-encode the map event, for example, based upon user preferences, and then transmits the re-encoded map event via a channel supporting the re-encoded format.

In another embodiment, the map event distribution platform 107 integrates the decoded map events into a website, and supports the reporting user to share the map events via one or more channels without leaving the website. In yet another embodiment, the map event distribution platform 107 integrates the third-party (e.g., a local traffic authority) generated map events on its website. Alternatively or concurrently, the local traffic authority can publish road works and closures on its own information feeds (e.g., a Twitter® channel, via a web feed, etc.).

In yet another embodiment, the map event distribution platform 107 determines to filter the map event information for presentation in the map display based, at least in part, on one or more criteria, such as event, location, content, contact, current location, message format, or a combination thereof. By way of example, map events of the same type (e.g., traffic jams, etc.) that affect the same road are detected and filtered as duplicates. In one embodiment, the platform 107 retains only the newest version of the map event. In another embodiment, the platform 107 retains the duplicates for statistics and analysis (e.g., for assembling validity and accuracy reports, for analyzing the creditability of reporting users, etc).

Since the map event distribution platform 107 uses the common communication channels to transmit map event messages, there is no need to create a custom channel. In this way, the map event distribution platform 107 conserves operational and computational resources. In addition, the map event distribution platform 107 takes advantage of the third party map event information to enrich the map and to verify user-reported map events, thus further conserving the operational and computational resources.

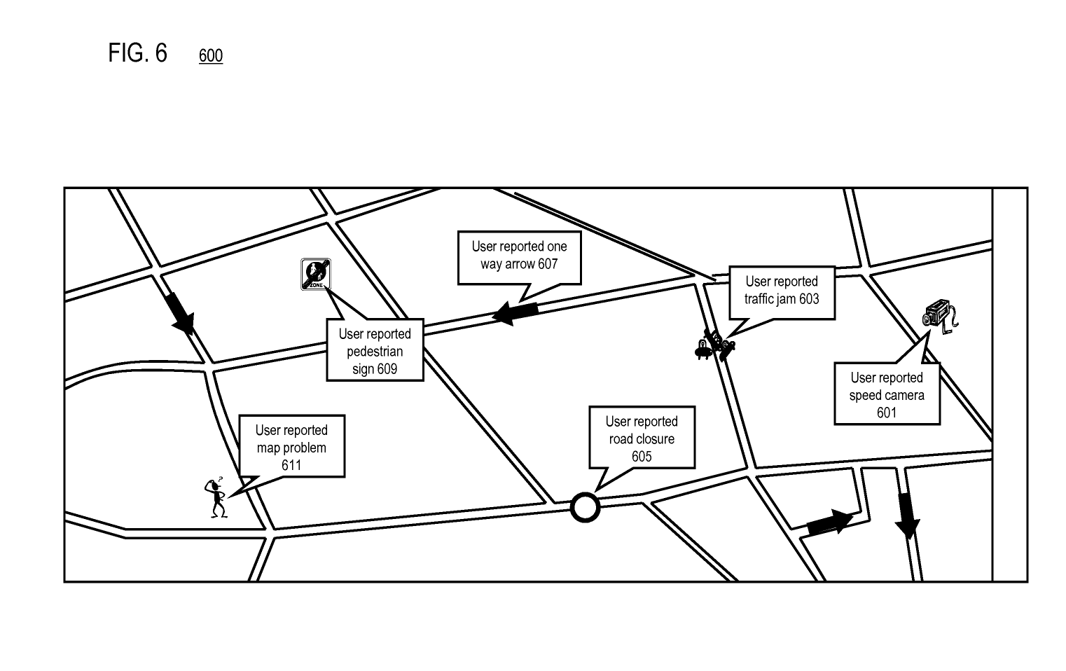

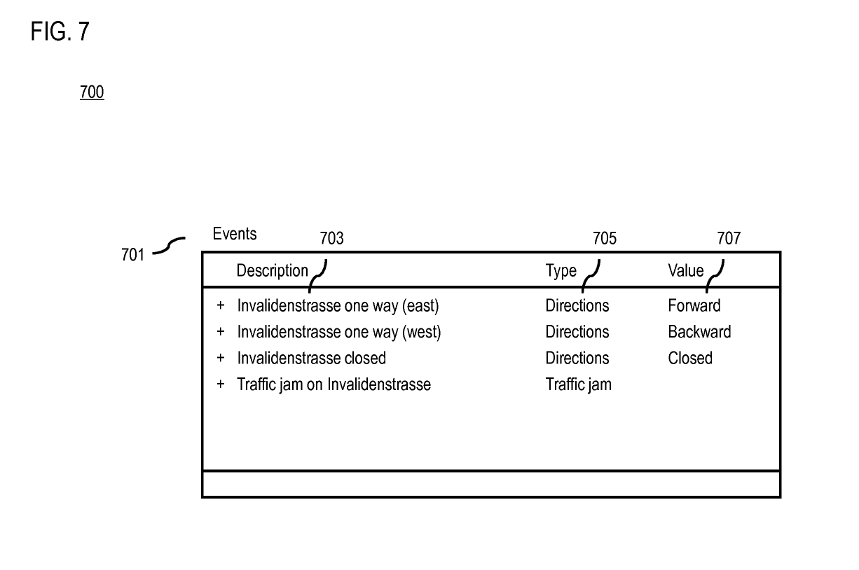

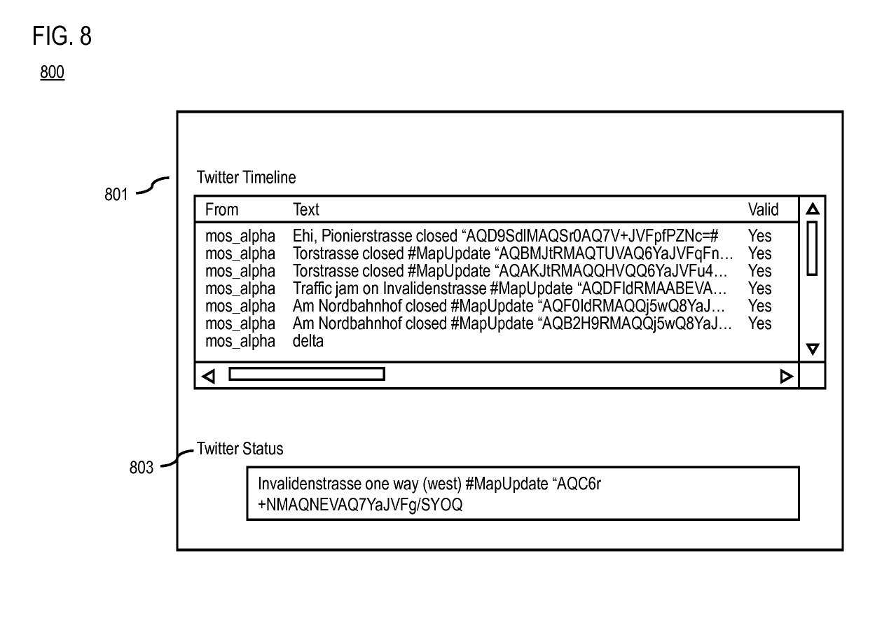

FIGS. 6-8 are diagrams of user interfaces utilized in the processes of FIGS. 4-5, according to various embodiments. Any two or more of FIGS. 6-8 may be assembled and shown within one user interface. By way of example, FIG. 6 can be placed on the right side of a user interface occupying about two thirds of the screen, while FIG. 7 is stacked on top of FIG. 8 and placed on the left side of the screen.

FIG. 6 is a diagram of a user interface of a map representation marked with map events, according to one embodiment. In one embodiment, the user interface 600 shows a map nada box on top of the map. By way of example, the map depicts a user-reported speed camera 601, traffic jam 603, road closure 605, one-way arrow 607, pedestrian sign 609, map problem 611, etc.

The system 100 may provide various map configuration control mechanisms. The user can set a longitude, latitude, altitude, scale, depth, etc. of a map object. The user can also set a configuration scheme of the map as a normal day. The user can further set a client type as default, and select the presentation mode as: Map Model Online (corresponding to the map in FIG. 6), Fast Move, or Statistics. The user can set a rotation scale, show prefix, display size, quad type, presentation effect, etc. The presentation effects may include 3D map, 3D landmark, crosshair, time zones, street lines, blocking, minimap, benchmark, debug layer, highway filter grid, memory consumption, etc.

By way of example, a report of a speed camera references a road, the position of the speed camera (lat, long), the orientation of the camera (forward or backward direction, relatively to the road default orientation, etc), and optionally, a speed threshold that triggers the camera. The report of the speed camera may expire after a predetermined time period (e.g., to model a temporary camera) or never expire (e.g., to model a fixed camera). Users can report speed cameras while driving, for example, by marking on the map in FIG. 6 on a user interface of the UE 101. A road, position and orientation of the camera can be determined automatically via a GPS receiver and the current status (e.g., a speed, direction, etc.) of the vehicle. The speed threshold can be set according to the speed limit of the road read from the map, if available. The map displays a speed camera as fixed (no expiration time) or mobile (with an expiration time). The users can manually provide missing information, or change the camera position to, e.g., “here”, “50 m before”, “250 m before”, “500 m before”, etc.

As another example, a report of a traffic jam references a road and the traffic flow affected by the jam (e.g., forward or backward, relatively to the road default orientation). The report of the traffic jam can expire after a predetermined time period. Users can report traffic jams when driving or when the UE 101 is in a tracking mode for the current road if the speed of the car is below a threshold. The road and its orientation can be determined automatically via a GPS receiver and the current status (e.g., a speed, direction, etc.) of the vehicle.

As yet another example, a report of a road closure and one way attribute changes references a road and traffic flows that are blocked (e.g., none, forward only, backward only, both, etc.). The report of the road closure and the one way attribute changes may expire after a predetermined time period (to model a temporary event) or never expire (to model a permanent change). Users can report road closures and one way attribute changes when the UE 101 is in a tracking mode. Users can select manually at a user interface of the UE 101 which road to report. Users may modify the report before sending or storing it locally, e.g., to specify an expiration period.

FIG. 7 is a diagram of a user interface showing map events, according to one embodiment. The user interface 700 shows an events box 701 In one embodiment, the Event box 701 shows the relevant map events with description 703, a type 705 (e.g., directions, traffic jam, etc.), and a value 707 (e.g., forward, backwards, closed, etc.). The user can store an event on the UE 101, affect the behavior of mapping and navigation system locally, to share with other users all the mp events stored on the UE 101, to remove single map events from the UE 101, to remove expired map events from the UE 101, to remove all stored map events from the UE 101, etc.

The map events listed in the events box 701 are shown in the map of FIG. 6, e.g., marked or highlighted on roads in the map. The user can select a map event in the events box 701 to trigger a special presentation (e.g., a popup box with information) referenced in the map of FIG. 6 with respect to the selected map event. Additional attributes, such as timestamps and reporting users, etc., may be shown in the special presentation. In another embodiment, the map events listed in the events box 701 can be sorted by any event attributes, such as timestamps, etc. Extra map events attributes may be shown within the events box 701.

The user can manually remove single map events, such as by selecting them from the map in FIG. 6 or from the Event list in FIG. 7. Removing single map events indicates that these map events are no longer valid. The user can restore the map of FIG. 6 to a designated time point. The user can clear all the map events stored locally via selecting a “reset” function, and a confirmation prompt is shown to avoid clearing all map events by mistake.

The system 100 can poll subscribed web feeds periodically to check if new entries are present. Web feed entries that, after being analyzed by the system 100, are classified as carrying valid map events and considered as candidate to be imported into the map of FIG. 6. The user interface 700 can implement a specific process to import candidate map events received from the web feeds, by involving the user to keep or discard each map event therein, or automatically import all or part of the candidate map events. The user interface 700 allows the user to add, edit, and remove single web feeds. The list of currently subscribed web feeds may be exportable in a standard format. The user interface 700 also allows the user to temporarily disable (pause) receiving updates via web feeds. The user interface 700 can personalize the web feed integration, e.g., which types to accept or discard automatically when received, the update frequency, etc.

FIG. 8 is a diagram of a user interface of map events, according to one embodiment. The user interface 800 shows a Twitter Timeline box 801, and a Twitter status box 803. The Twitter Timeline box 801 includes a list of twitted map event messages.

In one embodiment, the user can select the boxes to send or cancel map events via Twitter, to receive map events via Twitter, to resend map events received from other users via Twitter, to receive map events via web feeds (e.g., RSS), to manage web feed subscriptions, to add and/or remove web feeds, etc. By way of example, the user can highlight a message (e.g., a message from mos_delta with the text of “Traffic jam on Invalidenstrasse #MapUpdate *AQDFIdRAMABEVA . . . ”), then to re-encode and send a listed message to one or more other users.

The Twitter status box 803 shows the status of the selected map event message as “Invalidenstrasse one way (west) #MapUpdate *AQC6r+NMAQNEVAQ7YaJVFg/SYOQ=#”.

In one embodiment, the user interface 800 is interfaced to Twitter using the standard Twitter API. The user interface 800 can automatically login to Twitter using the user credentials. Otherwise, a login can be performed according to the Twitter API specification and the credentials are saved for future use. The user interface 800 provides the user with an option to logout from Twitter and to discard access credentials stored previously. In one embodiment, the user interface 800 sends map events via Twitter, encodes them using a compact string representation, adds a textual description that the user may modify, a hash tag and an URL to advertise the subject, the geo coordinates of the map event, etc. In another embodiment, the user interface 800 polls Twitter periodically to check if new map event messages are present on the user's Twitter timeline. Map event messages analyzed by the system 100 as carrying valid map events will be considered to be imported into the Twitter Timeline box 801.

The user interface 800 can implement a specific process to import candidate map events received from Twitter, by involving the user to keep or discard each map event, or automatically import all or part of the candidate map events. The user interface 800 can suggest the user to propagate accepted map events, either manually or automatically, and then resent them via Twitter. The user interface 800 can temporarily disable (pause) receiving updates via Twitter. The user interface 800 can personalize the Twitter integration, e.g., which map event types to report automatically or manually, which types to accept or discard automatically when received, which Twitter hash tags to automatically accept or discard, the polling frequency, etc.

The above-discussed embodiments generate map event messages that users can apply to their own maps or to share with other users via a platform. The application resides in the platform or the UE 101 encodes and decodes map events into messages in compact string representation, automatically or manually stores map events therein, and affects routing, navigation and rendering. The application also transmits externally the map events via messaging, web feeds, etc.

The above-discussed embodiments update map events any time regardless of the timing of updating the whole map, such that only a limited number of map objects are modified within the whole map. These event updates are done incrementally and/or in real time, and The above-discussed embodiments use these updates to generate additional notes or the like in the local map stored in the UE 101. These additions are small in size and can be efficiently distributed to other user devices as directed by the user or according the subscription by the other users to receive the map events of the user.

Since the system 100 uses the common communication channels to transmit map event messages, there is no need to create a custom channel. In this way, the system 100 conserves operational and computational resources. In addition, the system 100 takes advantage of the third party map event information to enrich the map and to verify user-reported map events, thus further conserving the operational and computational resources.

The processes described herein for distributing and displaying map events may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

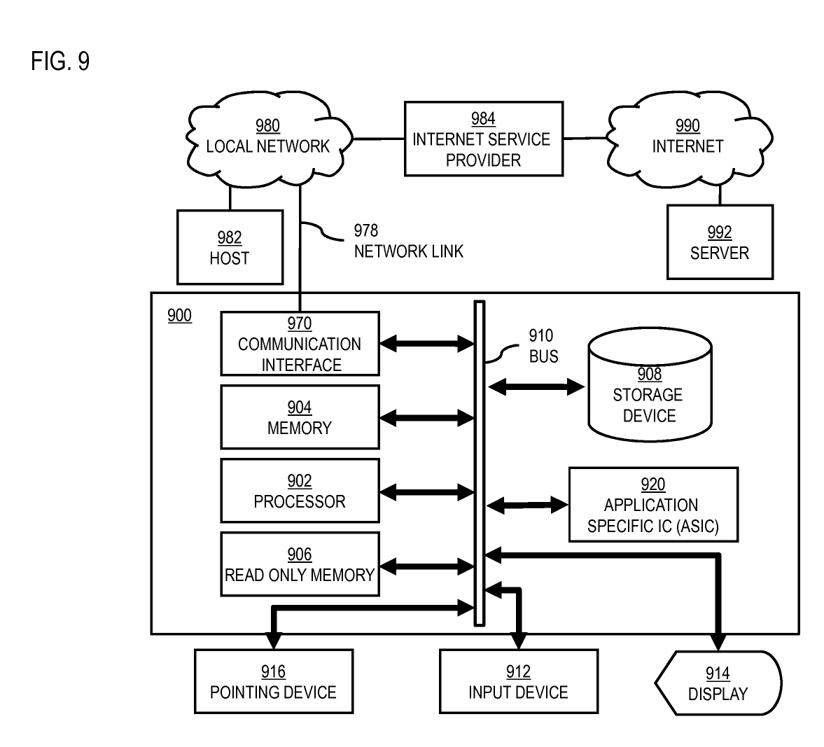

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to distribute and display map events as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of distributing and displaying map events.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to distribute and display map events. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or any other dynamic storage device, stores information including processor instructions for distributing and displaying map events. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for distributing and displaying map events, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for distributing and displaying map events to the UE 101 via a platform.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to distribute and display map events as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of distributing and displaying map events.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to distribute and display map events. The memory 1005 also stores the data associated with or generated by the execution of the inventive steps.

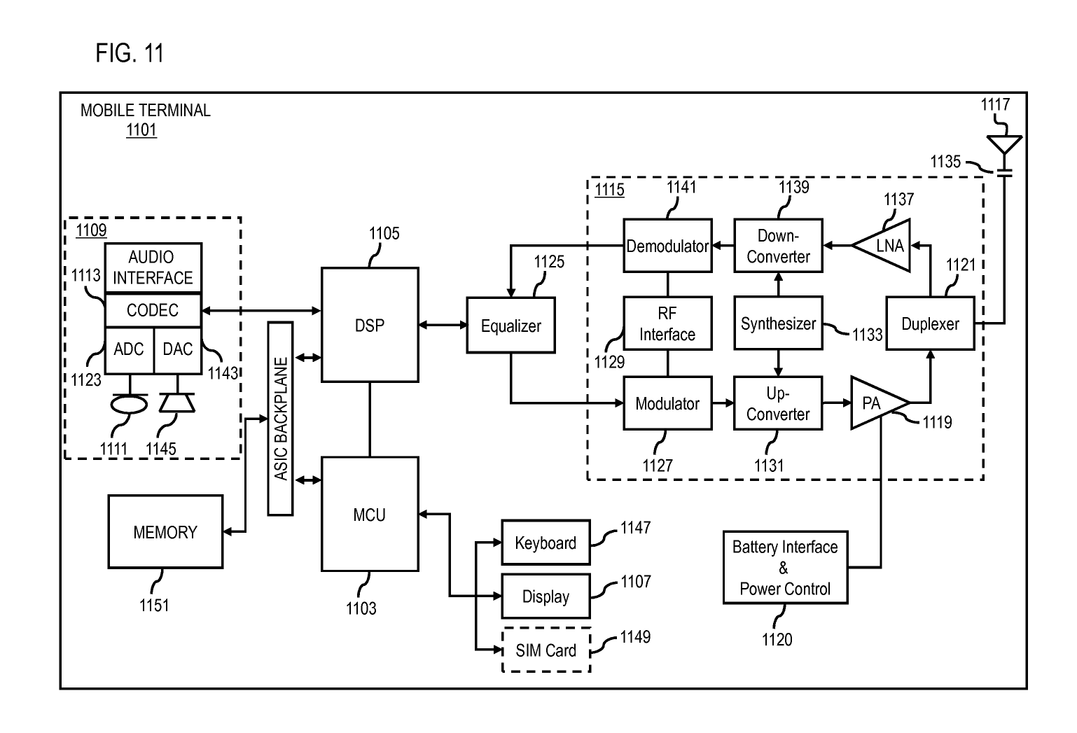

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of distributing and displaying map events. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of distributing and displaying map events. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to distribute and display map events. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
a processing of at least one map event specified by a user;
at least one determination to encode information regarding the at least one map event; and
at least one transmission of the encoded information to one or more devices associated with one or more other users,
wherein the map event information is processed, at least in part, to be associated with a map application.

2. A method of claim 1, wherein the (1) data and/or (2) information and/or (3) at least one signal are further based, at least in part, on the following:
context information associated with the map event information; and
at least one determination to include the context information in the encoded information.

3. A method of claim 1, wherein the (1) data and/or (2) information and/or (3) at least one signal are further based, at least in part, on the following:
a processing of at least one other map event to encode other information regarding the at least one other map event in the encoded information.

4. A method of claim 1, wherein the (1) data and/or (2) information and/or (3) at least one signal are further based, at least in part, on the following:
at least one determination of the one or more devices based, at least in part, on at least one social network, at least one social graph, or a combination thereof associated with the user.

5. A method of claim 4, further comprising:
receiving a subscription request for the at least one map event from at least one other user of the at least one social network.

6. A method comprising facilitating a processing of and/or processing (1) data and/or (2) information and/or (3) at least one signal, the (1) data and/or (2) information and/or (3) at least one signal based, at least in part, on the following:
encoded map event information;
at least one determination to decode the encoded map event information; and
a processing of the decoded map event information to associate the decoded map information with a map application.

7. A method of claim 6, wherein the (1) data and/or (2) information and/or (3) at least one signal are further based, at least in part, on the following:
determining that the decoded map event information relates to other map event information reported in at least one other map event message; and
determining context information associated with the decoded map event information, the other map event information, or a combination thereof,
wherein the association of the map event information, the other map event information, or a combination thereof with the map application is based, at least in part, on the context information.

8. A method of claim 7, wherein the (1) data and/or (2) information and/or (3) at least one signal are further based, at least in part, on the following:
determining validity information, accuracy information, or a combination thereof associated with the decoded map event information, the other map event information, or a combination thereof,
wherein the association of the map event information, the other map event information, or a combination thereof with the map application is based, at least in part, on the validity information, the accuracy information, or a combination thereof.

9. A method of claim 6, wherein the (1) data and/or (2) information and/or (3) at least one signal are further based, at least in part, on the following:
determining to re-encode the decoded map event information; and
causing, at least in part, transmission of the re-encoded map event information.

10. A method of claim 6, wherein the (1) data and/or (2) information and/or (3) at least one signal are further based, at least in part, on the following:
determining to filter the decoded map event information based, at least in part, on one or more criteria.

11. An apparatus comprising:
at least one processor; and
at least one memory including computer program code for one or more programs,
the at least one memory and the computer program code configured to, with the at least one processor, cause the apparatus to perform at least the following,
process and/or facilitate a processing of at least one map event specified by a user;
determine to encode information regarding the at least one map event; and
cause, at least in part, transmission of the encoded information to one or more devices associated with one or more other users,
wherein the map event information is processed, at least in part, to be associated with a map application.

12. An apparatus of claim 11, wherein the apparatus is further caused to:
determine context information associated with the map event information; and
determine to include the context information in the encoded information.

13. An apparatus of claim 11, wherein the apparatus is further caused to:
process and/or facilitate a processing of at least one other map event to encode other information regarding the at least one other map event in the encoded information.

14. An apparatus of claim 11, wherein the apparatus is further caused to:
determine the one or more devices based, at least in part, on at least one social network, at least one social graph, or a combination thereof associated with the user.

15. An apparatus of claim 11, wherein the apparatus is further caused to:
receive a subscription request for the at least one map event from at least one other user of the at least one social network.

16. An apparatus comprising:
at least one processor; and
at least one memory including computer program code for one or more programs,
the at least one memory and the computer program code configured to, with the at least one processor, cause the apparatus to perform at least the following,
receive encoded map event information;
determine to decode the encoded map event message; and
process and/or facilitate a processing of the decoded map event information to associate the decoded map event information with a map application.

17. An apparatus of claim 16, wherein the apparatus is further caused to:
determine that the decoded map event information relates to other map event information reported in at least one other map event message; and
determine context information associated with the decoded map event information, the other map event information, or a combination thereof,
wherein the association of the map event information, the other map event information, or a combination thereof with the map application is based, at least in part, on the context information.

18. An apparatus of claim 17, wherein the apparatus is further caused to:
determine validity information, accuracy information, or a combination thereof associated with the decoded map event information, the other map event information, or a combination thereof,
wherein the association of the map event information, the other map event information, or a combination thereof with the map application is based, at least in part, on the validity information, the accuracy information, or a combination thereof.

19. An apparatus of claim 16, wherein the apparatus is further caused to:
determine to re-encode the decoded map event information; and
cause, at least in part, transmission of the re-encoded map event information.

20. An apparatus of claim 16, wherein the apparatus is further caused to:
determine to filter the decoded map event information based, at least in part, on one or more criteria.
